(19) United States
(12) Patent Application Publication
(10) Pub. No.: US 2022/0157591 A1
(43) Pub. Date: May 19, 2022

(54) LASER COAXIAL ION EXCITATION DEVICE

(71) Applicant: ZHEJIANG DIGENA DIAGNOSIS TECHNOLOGY CO., LTD., Hangzhou (CN)

(72) Inventor: Shuanghong XIANG, Hangzhou (CN)

(21) Appl. No.: 17/666,634

(22) Filed: Feb. 8, 2022

Related U.S. Application Data
(63) Continuation of application No. PCT/CN2020/137862, filed on Dec. 21, 2020.

(30) Foreign Application Priority Data
Feb. 10, 2020 (CN) 202010084100.2

(51) Int. Cl. H01J 49/16; H01J 49/02

(52) U.S. Cl. CPC H01J 49/164; H01J 49/025

(57) ABSTRACT

A laser coaxial ion excitation device includes an optical center and an ion transmission channel. The optical center is hollow, the optical center is coaxial with the ion transmission channel, the ion transmission channel is perpendicular to the matrix carrier, laser focusing spots are focused in a non-uniform way, and a light path comprises, but not limited to, a laser transmission light path, a visually monitoring light path, a visual illumination light path and an optical intensity monitoring light path.

### CROSS REFERENCE TO RELATED APPLICATION

The present application is a continuation of PCT application No. PCT/CN2020/137862, filed on Dec. 21, 2020, which claims priority and benefit of China patent application No. 202010084100.2, filed on Feb. 10, 2020. PCT application No. PCT/CN2020/137862 and China patent application No. 202010084100.2 are incorporated herein in their entireties by reference and made a part of the present application.

### TECHNICAL FIELD

The present application relates to the field of matrix-assisted laser desorption/ionization time-of-flight mass spectrometry, and in particular, to a laser coaxial ion excitation device.

### BACKGROUND ART

Existing matrix-assisted laser desorption/ionization time-of-flight mass spectrometry equipment has complex structure, and it is difficult to adjust the laser excitation. The ion excitation is generally biased excitation. The spatial distribution of the excited ion cloud is asymmetric and widely distributed, which is not conducive to the ion flight after ion excitation. The ionization efficiency is not ideal, the resolution is not ideal, and the preparation cost is high. The existing biased excitation light path produces non-uniform spatial distribution, non-uniform ion charge distribution and non-uniform ion generation time distribution, which are the key factors affecting the detection results of mass spectrometry.

### SUMMARY

In order to solve the above technical solutions, the present application provides a laser coaxial ion excitation device with reasonable structure, forward excitation and adjustable focus.

A specific technical solution of the present application provides a laser coaxial ion excitation device, including an optical center and an ion transmission channel In particular, the optical center is hollow and coaxial with the ion transmission channel, the ion transmission channel is perpendicular to a matrix carrier, and laser focusing spots are focused in a non-uniform way. A light path includes, but not limited to, a laser transmission light path, a visually monitoring light path, a visual illumination light path and an optical intensity monitoring light path.

Specifically, the laser transmission light path includes, but not limited to, a laser device, a beam expander, a turning back mirror, a fully reflecting mirror and an objective lens arranged in sequence.

The visually monitoring light path includes, but not limited to, a laser transmission lens, a light-splitting lens and a lens set, and the visually monitoring light path is conjugate with the laser device.

The visual illumination light path includes, but not limited to, a visual light source, a light-splitting lens and a laser transmission lens, and the visual illumination light path is conjugate with the laser device.

The optical intensity monitoring light path includes, but not limited to, a photosensitive sensor.

The ion transmission channel includes, but not limited to, a variable curved surface ion lens, an ion filter screen and an ion detecting device. The laser device is used as the laser light source, and the ion detecting device is an existing structure.

Compared with the existing technology, the present application adopting the above structure has the following advantages. It has reasonable structure. The excitation light path is excited coaxially along the path of ion generation and ion flight, the spatial state generated by excitation is symmetrically distributed in the excitation point path, and the ion cloud generated by laser desorption/ionization is uniformly distributed in a space of about 10-200 μm from the excitation point. After focusing, there is relatively small spatial difference between ions. After ion flight, the resolution of mass spectrometry can be effectively improved.

Preferably, the objective lens is a hollow structure in which a hollow portion is used as an ion transmission channel, and the objective lens is perpendicular to the ion matrix carrier.

Preferably, the fully reflecting mirror is a hollow structure in which a hollow portion is an ion transmission channel, and the rest of the fully reflecting mirror is a reflective mirror.

Preferably, the turning back mirror is a fully reflective mirror, which has a central reflecting surface and an annular reflecting surface. The central reflecting surface reflects the central light source to the annular reflecting surface, and the annular reflecting surface coaxially reflects the laser along the incident light to form an annular laser transmission channel having a hollow center.

Preferably, the turning back mirror has a central hole or is fully transparent area, and the laser can directly reach the photosensitive sensor through the hole without reflection, so as to monitor or measure the laser intensity.

Preferably, the visual light source has a wavelength different from that of the laser device, and is used for synchronously monitoring the state of the matrix carrier or observing the laser excitation, focusing, and state adjustment. The visual light source is a parallel light or quasi parallel light source.

Preferably, the fully reflecting mirror is a single hollow fully reflecting mirror for fixed focus ion excitation or a hollow scanning mirror set for linear-scanning or surface-scanning ion excitation, in which the hollow scanning mirror set includes one hollow scanning mirror or two hollow scanning mirrors.

Preferably, a focusing lens set can be, but not necessarily, provided between the beam expander and the turning back mirror. The focusing lens set can act in combination with the visually monitoring device for adjusting the focusing position of the laser beam.

Preferably, the detection surface of the ion detecting device is coaxial with the ion transmission channel, and the photosensitive sensor is coaxial with the laser.

Further, the variable curved surface ion lens is coaxial with the ion transmission channel, and the variable curved surface ion lens is a controllable variable curved surface lens. The controllable variable surface lens can be selected from electric variable surface lens, hydraulic variable surface lens and pneumatic variable surface lens, and the electric variable surface lens is preferred.

### BRIEF DESCRIPTION OF THE DRAWINGS

FIG. 1 is a schematic diagram of an apparatus according to the present application.

FIG. 2 is a schematic diagram of energy focusing in the present application.

FIG. 3 is a schematic diagram of ionic intensity in the present application.

### DETAILED DESCRIPTION

The present application will be further described below in combination with embodiments.

### Embodiments

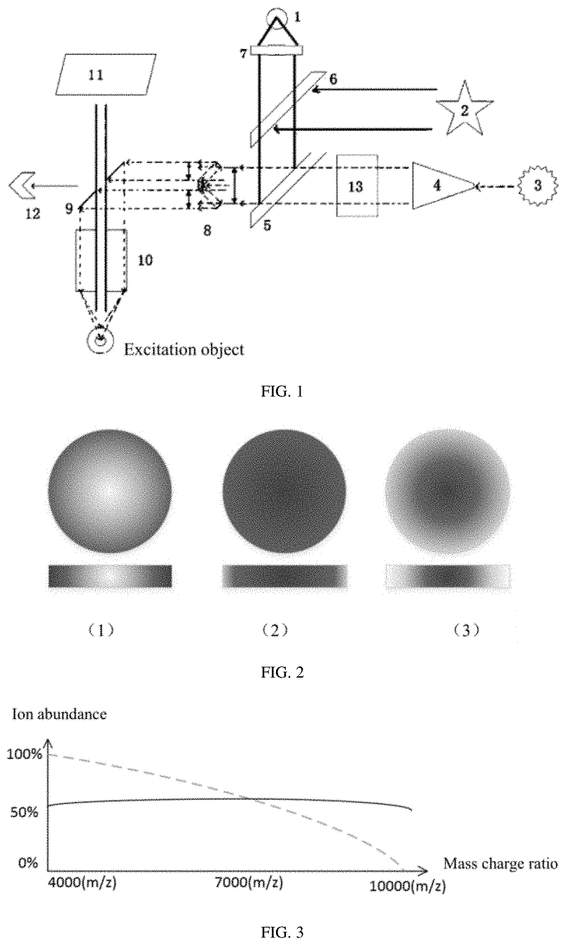

As shown in FIG. 1, a laser coaxial ion excitation device includes an optical center and an ion transmission channel The optical center is hollow, the optical center is coaxial with the ion transmission channel, the ion transmission channel is perpendicular to the matrix carrier, and the laser focusing spots are focused in a non-uniform way. The light path includes, but not limited to, a laser transmission light path, a visually monitoring light path, a visual illumination light path and an optical intensity monitoring light path. In particular, the laser transmission light path includes, but not limited to, a laser 3, a beam expander 4, a turning back mirror 8, a fully reflecting mirror 9 and an objective lens 10 arranged in sequence. The visually monitoring light path includes, but not limited to, a laser transmission lens 5, a light-splitting lens 6 and a lens set 7 arranged in sequence. The visually monitoring light path is conjugate with the laser 3 and performs monitoring via the camera 1. The visual illumination light path includes, but not limited to, a visual light source 2, a light-splitting lens 6 and a laser transmission lens 5, and the visual illumination light path is conjugate with the laser 3. The optical intensity monitoring light path includes, but not limited to, a photosensitive sensor 12. The ion transmission channel includes, but not limited to, an ion filter screen and an ion detecting device. A laser device is used as the laser light source, and the laser enters the laser transmission light path, successively passes through the beam expander 4, the laser transmission lens 5, the turning back mirror 8, the fully reflecting mirror 9, and enters the objective lens 10 and the photosensitive sensor 12. The ion detecting device is an existing structure and will not be described in detail. In particular, the focused laser spot energy is non-uniformly focused from the center to the periphery, and the size of the focused spot is 10 μm to 500 μm.

In particular, the objective lens is a hollow structure, in which the hollow portion is used as an ion transmission channel, and the objective lens is perpendicular to the matrix carrier. Similarly, the fully reflecting mirror is a hollow structure, in which the hollow portion is an ion transmission channel, and the rest is a reflective mirror. Further, the turning back mirror is a fully reflective mirror, which has a central reflecting surface and an annular reflecting surface. The central reflecting surface reflects the central light source to the annular reflecting surface, and the annular reflecting surface coaxially reflects the laser along the incident light to form an annular laser transmission channel with a hollow center. Moreover, the turning back mirror has a central hole or is a fully transparent area, and the laser can directly reach the photosensitive sensor through the hole without reflection, so as to monitor or measure the laser intensity.

The visual light source has a wavelength different from that of the laser device. It is used for monitoring the state of the matrix carrier synchronously, or can be used for adjusting or monitoring laser exciting and focusing. The visual light source is a parallel light source or quasi parallel light source, such as halogen light source and LED light source.

In addition, the fully reflecting mirror is a single hollow fully reflecting mirror for fixed focus ion excitation or a hollow scanning mirror set for linear-scanning or surface-scanning ion excitation, in which the hollow scanning mirror set includes one hollow scanning mirror or two hollow scanning mirrors. In addition, a focusing lens set 13 may be, but not necessarily, provided between the beam expander and the turning back mirror. The focusing lens set can act in combination with the visually monitoring device to adjust the focusing position of the laser beam. Moreover, the detection surface of the ion detecting device is coaxial with the ion transmission channel, and the photosensitive sensor is coaxial with the laser.

Further, the focused laser spot energy is non-uniformly focused from the center to the periphery, and the size of the focused laser spot is 10 μm to 500 μm.

Through the above settings, ions are coaxially excited and focused to form spatial distribution. In particular, the excitation light path performs excitation coaxially along the path of ion generation and ion flight, the spatial state generated by excitation is symmetrically distributed around the excitation point, and the ion cloud generated by laser desorption/ionization is uniformly distributed in a space of about 10-200 μm from the excitation point. After focusing, there is a relatively small spatial difference between ions. After ion flight, the resolution of mass spectrometry can be effectively improved.

The uniformly distributed non-uniform energy focusing mode improves the excitation efficiency of mass charge ratio in a wide range. When the mass range is relatively small during mass spectrometry detection, the laser energy required for matrix carrier laser desorption/ionization is roughly the same, and uniform excitation energy is required at the excitation point for producing uniform excited ions. When the mass range is relatively large during mass spectrometry detection, different laser energies are required to excite ions with different molecular weights, that is, the excitation needs to be differentiated, so that the number of excited ions having large molecular weight and small molecular weight is basically balanced in the mass range, and the mass range can be extended to a relatively large range. The providing of the hollow light path forms a non-uniform laser energy distribution at the excitation point. When the laser intensity is constant, the present application can be adapted to the mass range of 100-1000000 molecular weights by adjusting the energy distribution of the excitation point. When the molecular weight range is narrow, such as 1000-3000 or 4000-8000, the focusing mode in FIG. 2 can be selected, so that the excitation efficiency and molecular weight distribution are balanced. When the mass range is large and the mass charge ratio is relatively high, such as 10000-500000, the focusing modes in FIGS. 2 and 3 can be selected, in which the laser energy is relatively concentrated, and there are a smaller number of excited ions having small molecular weight and a larger number of excited ions having large molecular weight. When the mass range is large and the mass charge is relatively low, that is, 100-100000, the focusing mode of 1 in FIG. 2 can be selected, so that the excitation efficiency of low molecular weight ions is low and the excitation efficiency of high molecular weight ions is high. The laser energy non-uniformly distributed on the excitation point can effectively balance the excitation energy required by the molecular weights and the difference between the numbers of excited ions having high and low molecular weights within the mass range. The beneficial effect is shown in the dotted line in FIG. 3. When the laser on the excitation point is uniform distributed, the excitation efficiency of ions tends to decline with the increase of molecular weight, and the ion intensity can become basically straight in the mass range by adjusting the laser energy at the excitation point, as shown in the solid line in FIG. 3. When the ion abundance curve is basically uniform, the sensitivity requirements can be met by increasing the laser intensity or the magnification of the ion detector. At the same time, the requirements of resolution and sensitivity are considered.

Coaxial high-speed dynamic scanning is performed. When a single hollow fully reflecting mirror is selected, the matrix carrier can be excited by fixing the focus. When a hollow scanning mirror set is selected, the laser can perform scanning and exciting according to a predetermined track to form a linear, surface and curve scanning mode. After synthesizing, the scanning data can form the point, line and surface scanning images of the matrix carrier.

Excitation or focusing process is real time monitored. Through the coaxial monitoring light source and monitor, the real-time images of the excitation and focusing process can be observed, and then the state to be reached for excitation and focusing can be confirmed.

Excitation energy is monitored in closed loop. At present, after outputting the laser, the laser energy cannot be effectively monitored, and it cannot be confirmed whether the excitation is successful or whether the exciting energy and excitation delay can meet expected requirements. The present application also has the advantages that the photosensitive sensor can monitor whether the energy of each laser pulse has been output as expected and whether the excitation delay meets the expected use when the laser performs exciting. When monitoring the laser energy, the photosensitive sensor can be, but not limited to, the photosensitive resistance and photodiode having a wavelength corresponding to the laser wavelength. When monitoring the time of laser excitation delay, it can be, but not limited to, the photosensitive triode and optical fiber photoelectric sensor having a wavelength corresponding to the laser wavelength. Thus, the whole structure is reasonable and simple, providing good use effect, wide mass range of ions, high resolution, and effectively improved ion excitation abundance.

Unless otherwise specified, the raw materials and equipment used in the present application are common raw materials and equipment in the art. Unless otherwise specified, the methods used in the present application are conventional methods in the art.

The above is only a preferred embodiment of the present application and does not limit the present application. Any simple modification, change and equivalent transformation of the above embodiment according to the technical essence of the present application still belong to the protection scope of the technical scheme of the present application.

What is claimed is:

1. A laser coaxial ion excitation device, comprising an optical center and an ion transmission channel, wherein the optical center is hollow, the optical center is coaxial with the ion transmission channel, the ion transmission channel is perpendicular to a matrix carrier, laser focusing spots are focused in a non-uniform way, and a light path comprises a laser transmission light path, a visually monitoring light path, a visual illumination light path and an optical intensity monitoring light path.

2. The laser coaxial ion excitation device according to claim 1, wherein the laser transmission light path comprises a laser, a beam expander, a turning back mirror, a fully reflecting mirror and an objective lens arranged in sequence;
the visually monitoring light path comprises a laser transmission lens, a light-splitting lens and a lens set, and the visually monitoring light path is conjugate with the laser coaxial ion excitation device;
the visual illumination light path comprises a visual light source, a light-splitting lens and a laser transmission lens, and the visual illumination light path is conjugate with the laser coaxial ion excitation device;
the optical intensity monitoring light path comprises a photosensitive sensor; and
the ion transmission channel comprises a variable curved surface ion lens, an ion filter screen and an ion detecting device.

3. The laser coaxial ion excitation device according to claim 2, wherein the objective lens is a hollow structure, a hollow portion is used as an ion transmission channel, and the objective lens is perpendicular to the matrix carrier.

4. The laser coaxial ion excitation device according to claim 2, wherein the fully reflecting mirror is a hollow structure, a hollow portion is an ion transmission channel, and the rest of the fully reflecting mirror is a reflective mirror.

5. The laser coaxial ion excitation device according to claim 2, wherein the turning back mirror is a fully reflective mirror having a central reflecting surface and an annular reflecting surface, the central reflecting surface reflects a central light source to the annular reflecting surface, and the annular reflecting surface coaxially reflects the laser along incident light to form an annular laser transmission channel with a hollow center.

6. The laser coaxial ion excitation device according to claim 5, wherein the turning back mirror has a central hole or is a fully transparent area, and laser directly reach the photosensitive sensor through the hole without reflection, so as to monitor or measure laser intensity.

7. The laser coaxial ion excitation device according to claim 2, wherein the visual light source has a wavelength different from that of the laser coaxial ion excitation device, and is configured to monitor a state of the matrix carrier synchronously, or adjust excitation or focusing of the laser.

8. The laser coaxial ion excitation device according to claim 2, wherein the fully reflecting mirror is a single hollow fully reflecting mirror for fixed focus ion excitation or a hollow scanning mirror set for linear-scanning or surface-scanning ion excitation, and the hollow scanning mirror set comprises one hollow scanning mirror or two hollow scanning mirrors.

9. The laser coaxial ion excitation device according to claim 2, wherein a focusing lens set is provided between the beam expander and the turning back mirror, and is configured to act in combination with the visually monitoring device for adjusting focusing position of a laser beam.

10. The laser coaxial ion excitation device according to claim 1, wherein energy of focused laser spots is non-uniformly focused from a center to periphery, and the focused laser spots have a size of 10 μm to 500 μm.
